(19) United States
(12) Patent Application Publication
(10) Pub. No.: US 2023/0096998 A1
(43) Pub. Date: Mar. 30, 2023

(54) MOVING OBJECT

(71) Applicant: HONDA MOTOR CO., LTD., Tokyo (JP)

(72) Inventor: Takamasa MORI, Tokyo (JP)

(73) Assignee: HONDA MOTOR CO., LTD., Tokyo (JP)

(21) Appl. No.: 17/941,651

(22) Filed: Sep. 9, 2022

(30) Foreign Application Priority Data
Sep. 29, 2021 (JP) 2021-160170

(51) Int. Cl. H01M 50/249; H01M 10/0525; H01M 10/0585; H01M 10/42; H01M 50/204; H01M 50/289

(52) U.S. Cl. CPC H01M 50/249; H01M 10/0525; H01M 10/0585; H01M 10/425; H01M 10/4207; H01M 50/204; H01M 50/289; H01M 2220/20

(57) ABSTRACT

A moving object according to the present disclosure includes: a frame; and a solid-state battery placed in a hollow of the frame. According to the present disclosure, rigidity of the frame can be increased without additional components, and an increase in weight can be prevented. In addition, a space conventionally secured for placing a battery can be freed, and room in the interior of the moving object can be enlarged.

CROSS-REFERENCE TO RELATED APPLICATION

This application is based on and claims priority under 35 USC § 119 from Japanese Patent Application No. 2021-160170, filed on Sep. 29, 2021, the entire contents of which are incorporated herein by reference.

### TECHNICAL FIELD

The present disclosure relates to a moving object including a solid-state battery.

### BACKGROUND

In recent years, the realization of a low-carbon or decarbonized economy has been called for to tackle global climate change. Reducing CO₂ emissions from moving objects, such as vehicles, electrification of drive sources has been rapidly promoted. Specifically, vehicles, such as electric vehicles and hybrid electric vehicles, including an electric motor as a drive source and a rechargeable battery configured to supply electricity to the electric motor have been developed.

Solid-state batteries have also been developed. In general, they are more shock-resistant than conventional batteries with an electrolytic solution are. JP2017-185948A discloses a battery placement structure in which a solid-state battery is configured to maintain rigidity of a vehicle by providing an impact-absorbing member in a hollow of a frame such that it faces a battery pack accommodating the solid-state battery.

Addition of such an impact-absorbing member, however, increases the weight of the vehicle. Since solid-state batteries are not only more shock-resistant but also more heat-resistant than the conventional batteries are, they can be placed more freely in vehicles.

The present disclosure provides a moving object including a solid-state battery that can reduce the weight.

### SUMMARY

A moving object according to the present disclosure includes: a frame; and a solid-state battery placed in a hollow of the frame.

According to the present disclosure, a moving object including a solid-state battery that can reduce the weight is provided.

### BRIEF DESCRIPTION OF DRAWINGS

Exemplary embodiments of the present disclosure will be described in detail based on the following figures, wherein:

FIG. 1 is a perspective view of a lower part of a moving object 1;

FIG. 2 is a cross-sectional view taken along a line A-A shown in FIG. 1;

FIG. 3 is a cross-sectional view of the moving object 1 according to a first modification taken along the line A-A;

FIG. 4 is a cross-sectional view of the moving object 1 according to a second modification taken along the line A-A;

FIG. 5 is a cross-sectional view of the moving object 1 according to a third modification taken along the line A-A; and

FIG. 6 is a cross-sectional view of the moving object 1 according to a fourth modification taken along the line A-A.

### DESCRIPTION OF EMBODIMENTS

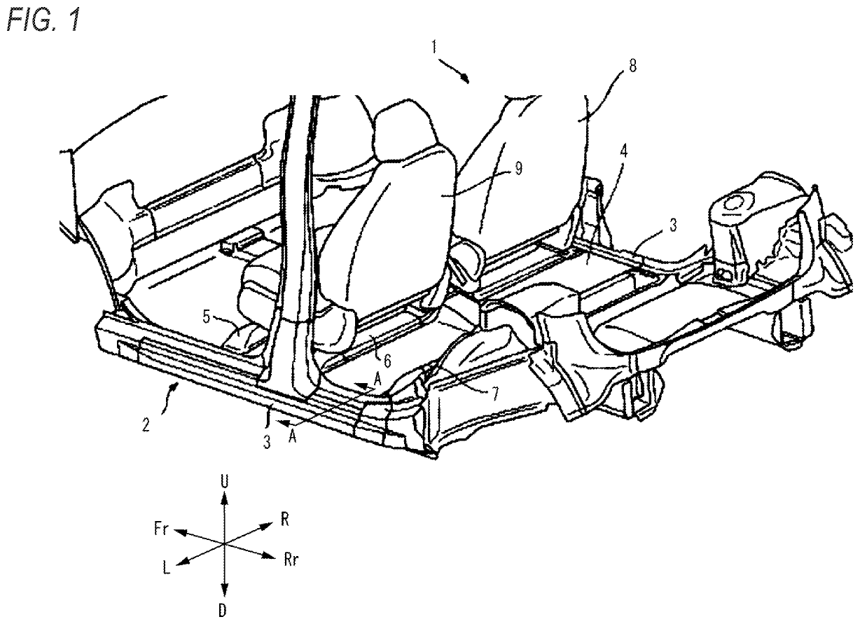

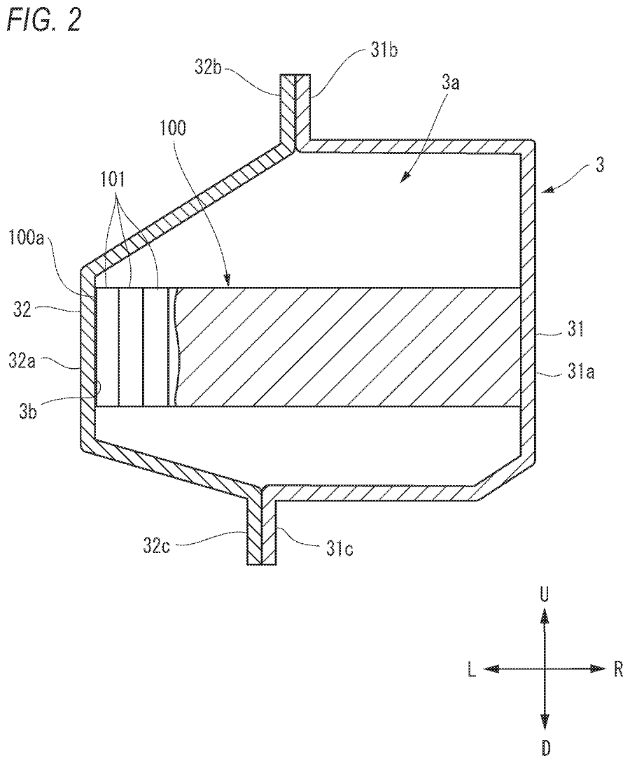

A moving object according to an embodiment of the present disclosure will be described in the following with reference to FIGS. 1 and 2. In the drawings, “Fr” denotes the front direction as viewed from a driver of the moving body, “Rr” the rear direction, “L” the left direction, “R” the right direction, “U” the upper direction, and “D” the down direction.

The moving object 1 according to the present embodiment is, for example, an electrically powered vehicle including a lower part 2 as shown in FIG. 1. The lower part 2 includes: left and right sills 3; a floor panel 4; a plurality of floor beams 5 to 7; the driver's seat 8; and a passenger seat 9. In the following, the front-rear direction will be referred to as a “vehicle length direction,” the left-right direction as a “vehicle width direction,” and the up-down direction as a “vehicle height direction.”

Each of the sills 3 is provided in an end part of the moving object 1 in the vehicle width direction and extends in the vehicle length direction. The floor panel 4 is placed between the sills 3. The floor beams 5 to 7 are arranged on an upper surface of the floor panel 4 at predetermined intervals in the vehicle length direction and are placed between the sills 3 in the vehicle width direction. Although only the left sill 3 will be described in the following, the right sill 3 is configured similarly.

As shown in FIG. 2, the sill 3 is a frame having a hollow 3a and includes an outer sill 32 and an inner sill 31 in the vehicle width direction.

The outer sill 32 includes: a bulge 32a; an upper flange 32b; and a lower flange 32c. The bulge 32a protrudes outward in the vehicle width direction from the upper flange 32b and the lower flange 32c. The upper flange 32b protrudes upward from an upper end of the bulge 32a, and the lower flange 32c protrudes downward from a lower end of the bulge 32a.

The inner sill 31 includes: a bulge 31a; an upper flange 31b; and a lower flange 31c. The bulge 31a protrudes inward in the vehicle width direction from the upper flange 31b and the lower flange 31c. The upper flange 31b protrudes upward from an upper end of the bulge 31a, and the lower flange 31c protrudes downward from a lower end of the bulge 31a.

The sill 3, which has the hollow 3a, is formed by joining the upper flanges 32b and 31b and joining the lower flanges 32c and 31c.

The moving object 1 further includes a solid-state battery 100 as a power source of a traveling motor. In the solid-state battery 100, a plurality of cells 101 is laminated. Each of the cells 101 includes: an anode; a cathode; and a solid electrolyte placed between the anode and the cathode. Each of the cells 101 is charged or discharged by exchanging lithium ions between the anode and the cathode via the solid electrolyte.

Any materials can be used as the solid electrolyte as long as they have lithium-ion conductivity and electrical non-conductivity. For example, the following can be used as the solid electrolyte: materials used in all-solid-state lithium-ion batteries; inorganic solid electrolyte materials such as sulfide solid electrolyte materials, oxide solid electrolyte materials, and lithium-containing salts; polymer-based solid electrolyte materials such as polyethylene oxide; and gel-based solid electrolytes with lithium-containing salts or ionic liquids having lithium-ion conductivity. The solid electrolyte may be granular.

As shown in FIG. 2, the solid-state battery 100 is placed in the hollow 3a of the sill 3, which is a frame. Therefore, rigidity of the sill 3 can be increased without additional components, and an increase in weight can be prevented. In addition, a space conventionally secured for placing a battery can be freed, and room in the vehicle interior can be enlarged.

The solid-state battery 100 is placed such that a side surface 100a, which faces outward in the vehicle width direction, faces a side wall 3b of the sill 3. According to this configuration, an impact of a side collision is transmitted to the solid-state battery 100, which is rigid. If the solid-state battery 100 is placed such that a surface facing outward in the vehicle length direction faces a wall of a frame, an impact of a frontal or rear collision is transmitted to the solid-state battery 100.

In general, solid-state batteries have excellent impact resistance in a lamination direction, in which cells are laminated. In FIG. 2, the lamination direction of the cells 101 of the solid-state battery 100 faces in the vehicle width direction (the left-right direction). Therefore, an impact of a side collision in the vehicle width direction is transmitted to the solid-state battery 100, although the lamination direction may face in the vehicle length direction.

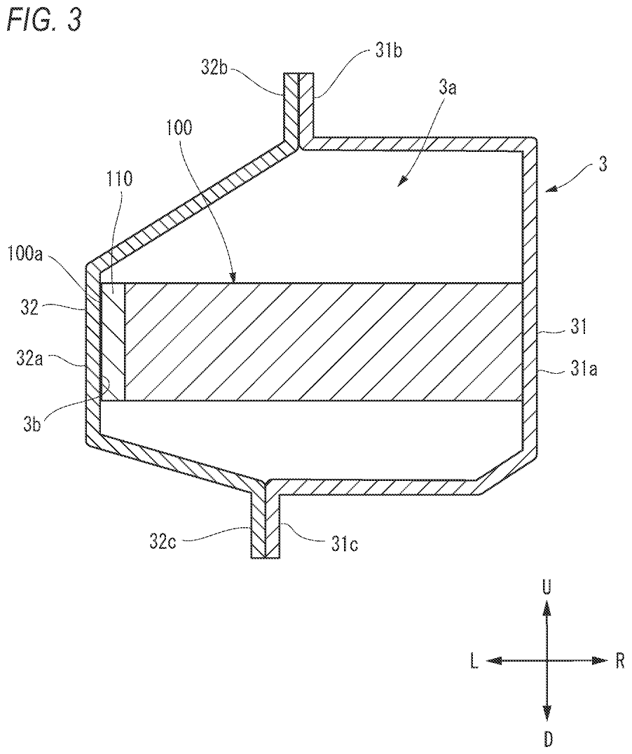

Next, first to fourth modifications of the present disclosure will be described with reference to FIGS. 3 to 6. In the following, a reference sign common to the above embodiment and the modifications refers to a common configuration.

As shown in FIG. 3, in the moving object 1 according to the first modification, an elastic material 110 is provided between the side surface 100a of the solid-state battery 100 and the side wall 3b of the sill 3. According to this configuration, an impact is more effectively transmitted to the solid-state battery 100 via the elastic material 110. The elastic material 110 is, for example, a spring, resin, rubber, or a cushion.

Similarly to the above embodiment, it is preferable that the side surface 100a and the side wall 3b face each other in the lamination direction of the cells 101.

A volume of solid-state batteries changes according to their state of charge (SoC). For example, cells expand when SoC increases from 75% to 100% and shrink when the SoC decreases from 75% to 50%. In the first modification, the elastic material 110 can absorb the change in the volume according to SoC, thereby preventing occurrence of a gap between the side surface 100a and the side wall 3b.

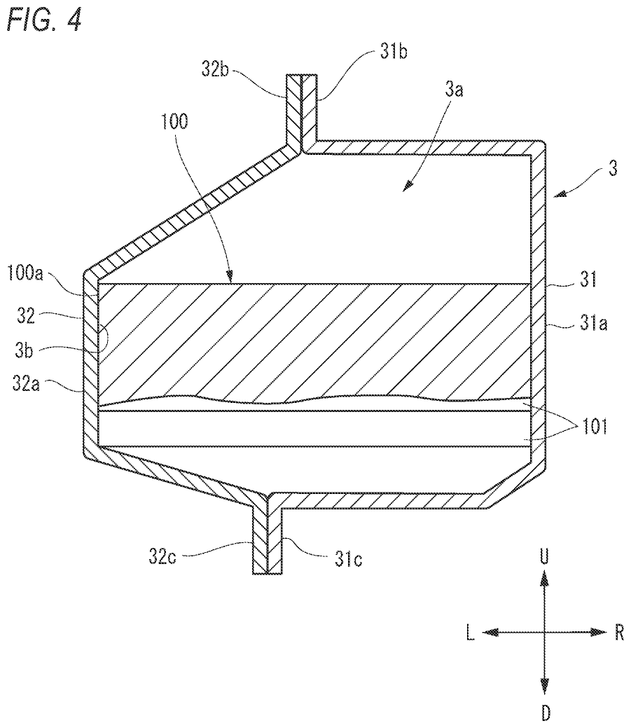

As shown in FIG. 4, in the moving object 1 according to the second modification, the lamination direction of the cells 101 faces in the vehicle height direction. In this configuration, no gap occurs between the side surface 100a and the side wall 3b even when the solid-state battery 100 expands or shrinks according to SoC. Therefore, rigidity of the sill 3 can be secured.

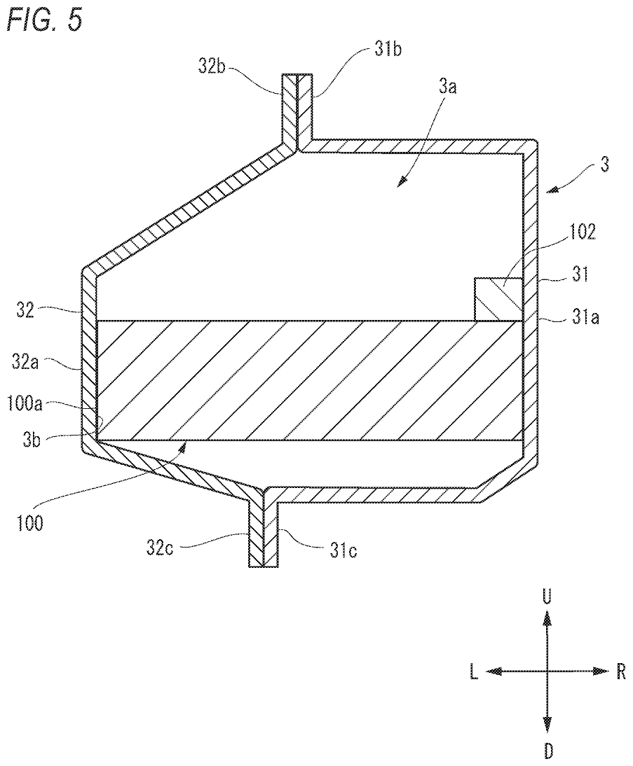

As shown in FIG. 5, in the moving object 1 according to the third modification, the solid-state battery 100 is provided with a wiring portion 102 via which the solid-state battery 100 is electrically connected to an electrical device, such as an inverter. The wiring portion 102 is closer to the center of the moving object 1 in the vehicle width direction than the center of the solid-state battery 100 in the vehicle width direction. According to this configuration, the electrical device is close to the wiring portion 102, and shortening of wiring can be achieved. In addition, the wiring portion 102 can be protected from an impact of a collision.

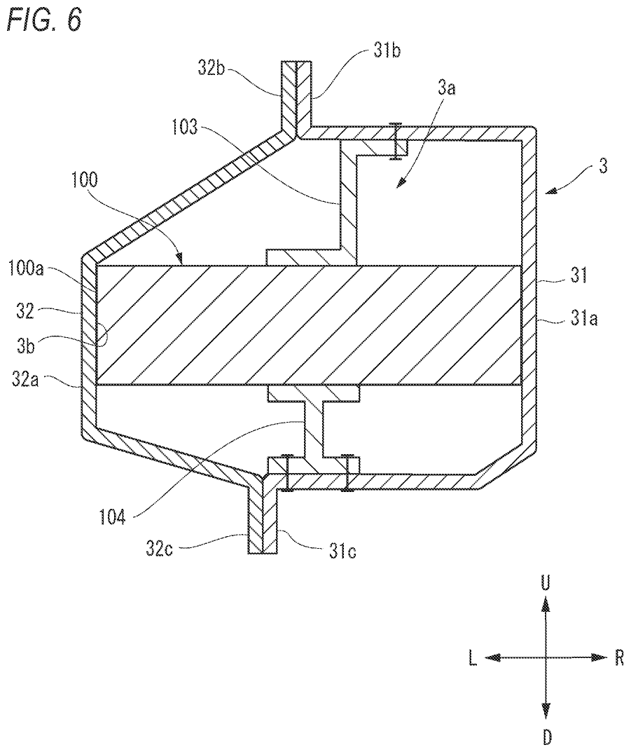

As shown in FIG. 6, in the moving object 1 according to the fourth modification, support members 103 and 104, such as brackets, connect the solid-state battery 100 and the sill 3. It is preferable that the support members 103 and 104 connect the solid-state battery 100 and the sill 3 in the vehicle height direction. Inside a frame, a space can be secured more easily in the vehicle height direction than in the vehicle length or the vehicle width direction. According to this configuration, the solid-state battery 100 can be fixed to the sill 3 appropriately.

In addition, it is preferable that the support members 103 and 104 support the middle of the solid-state battery 100 in the vehicle length and the vehicle width direction. This configuration can reduce concentration of stress in the solid-state battery 100 when an impact of a side collision is applied to the solid-state battery 100 via the support members 103 and 104.

Although embodiments have been described above with reference to the drawings, it goes without saying that the present disclosure is not limited thereto. Those skilled in the art may conceive various changes or modifications within the scope of the claims, or the technical scope of the present disclosure. Components in the embodiments can be arbitrarily combined within the gist of the present disclosure.

The sill 3 is merely an example of a frame having a hollow: the frame may be, for example, the floor beams 5 to 7 extending in the vehicle width direction or a pillar extending in the vehicle height direction as long as they have a hollow in which the solid-state battery 100 can be placed.

The electrically powered vehicle, such as a hybrid vehicle, a fuel-cell vehicle, and an electric vehicle, is merely an example of the moving object 1: the moving object 1 may be, for example, a ship, an aircraft, a snow-plow, a lawn mower, or the like.

At least the following are described in the present description. Although corresponding components or the like in the above embodiment are shown in parentheses, the present disclosure is not limited thereto.

(1) A moving object (1), including:
a frame (the sill 3) having a hollow (3a); and
a solid-state battery (100) placed in the hollow of the frame.

According to (1), rigidity of the frame can be increased without additional components, and an increase in weight can be prevented. In addition, a space conventionally secured for placing a battery can be freed, and room in the interior of the moving object can be enlarged.

(2) The moving object according to (1), in which
a side surface (100a) of the solid-state battery facing outward in a length direction or a width direction of the moving object faces a wall (the side wall 3b) of the frame.

According to (2), an impact of a collision is transmitted to the solid-state battery, which is rigid.

(3) The moving object according to (2), in which
an elastic material (110) is provided between the side surface of the solid-state battery and the wall of the frame.

According to (3), the impact is more effectively transmitted to the solid-state battery.

(4) The moving object according to (3), in which
a plurality of cells (101) is laminated in a lamination direction in the solid-state battery, and
the side surface of the solid-state battery and the wall of the frame face each other in the lamination direction.

According to (4), the elastic material can absorb change in volume of the solid-state battery according to its SoC, thereby preventing occurrence of a gap between the side surface of the solid-state battery and the wall of the frame.

(5) The moving object according to (2), in which
a plurality of cells (101) is laminated in a lamination direction in the solid-state battery, and
the lamination direction faces in a height direction of the moving object.

According to (5), no gap occurs between the side surface of the solid-state battery and the wall of the frame even when the solid-state battery expands or shrinks according to its SoC. Therefore, rigidity of the frame can be secured.

(6) The moving object according to any one of (1) to (5), further including an electrical device, in which
the solid-state battery includes a wiring portion (102) via which the solid-state battery is electrically connected to the electrical device, and
the wiring portion is closer to a center of the moving object than a center of the solid-state battery.

According to (6), the electrical device is close to the wiring portion, and shortening of wiring can be achieved. In addition, the wiring portion can be protected from an impact of a collision.

(7) The moving object according to any one of (1) to (6), further including:
a support member (103 and 104) connecting the solid-state battery and the frame in a height direction of the moving object.

According to (7), since a space can be secured inside the frame more easily in the height direction than in a length direction or a width direction of the moving object, the solid-state battery can be fixed to the frame appropriately.

(8) The moving object according to (7), in which
the support member supports a middle of the solid-state battery in a length direction or a width direction of the moving object.

According to (8), concentration of stress in the solid-state battery can be reduced when an impact of a collision is applied to the solid-state battery via the support member.

1. A moving object, comprising:
a frame having a hollow; and
a solid-state battery placed in the hollow of the frame.

2. The moving object according to claim 1, wherein
a side surface of the solid-state battery facing outward in a length direction or a width direction of the moving object faces a wall of the frame.

3. The moving object according to claim 2, wherein
an elastic material is provided between the side surface of the solid-state battery and the wall of the frame.

4. The moving object according to claim 3, wherein
a plurality of cells is laminated in a lamination direction in the solid-state battery, and
the side surface of the solid-state battery and the wall of the frame face each other in the lamination direction.

5. The moving object according to claim 2, wherein
a plurality of cells is laminated in a lamination direction in the solid-state battery, and
the lamination direction faces in a height direction of the moving object.

6. The moving object according to claim 1, further comprising an electrical device, wherein
the solid-state battery includes a wiring portion via which the solid-state battery is electrically connected to the electrical device, and
the wiring portion is closer to a center of the moving object than a center of the solid-state battery.

7. The moving object according to claim 1, further comprising:
a support member connecting the solid-state battery and the frame in a height direction of the moving object.

8. The moving object according to claim 7, wherein
the support member supports a middle of the solid-state battery in a length direction or a width direction of the moving object.
